(19) United States
(12) Patent Application Publication
(10) Pub. No.: US 2021/0233176 A1
(43) Pub. Date: Jul. 29, 2021

(54) COMPUTER SYSTEM AND METHOD FOR A WITHDRAWAL TOOL

(71) Applicant: Wells Fargo Bank, N.A., San Francisco, CA (US)

(72) Inventors: Chad Allen Yarbrough, St. Louis, MO (US); Christopher J. Healey, Charlotte, NC (US); Linda Joan Berne, Evanston, IL (US); Donna Lee Peterson, Seagrove, NC (US)

(21) Appl. No.: 14/540,925

(22) Filed: Nov. 13, 2014

(51) Int. Cl. G06Q 40/06

(52) U.S. Cl. CPC G06Q 40/06

(57) ABSTRACT

A computer system and method for use in retirement planning comprising identifying by a computer a financial account within a retirement plan, assigning by the computer a unique code to each type of transaction activity for the financial account, identifying by the computer an actual withdrawal transaction by the unique code, and calculating an amount withdrawn from the retirement plan based on aggregating transaction amounts for the unique codes representing the actual withdrawal transaction.

### FIELD OF THE INVENTION

The present invention relates to a computer system and computer-implemented method for use in retirement income planning, more particularly to an interactive computer system having a computer software application tool for identifying withdrawal activity and integrating the withdrawal activity with a retirement plan.

### BACKGROUND OF THE INVENTION

There is a need for a financial planning tool that answers the question, “How does what I planned to take out of my portfolio compare to what I am actually taking?” Currently, financial advisors have no simple way to see how much money has actually been withdrawn across all accounts in a household. Financial advisors spend time developing and maintaining a plan, but they do not have integrated tools to review whether the client is sticking to the plan when it comes to their annual withdrawals. For a plan to be successful over the long term, withdrawals need to be monitored to ensure they are in line with the recommended spending need.

Thus, there is a desire for a person approaching retirement to gain an understanding of how and where his or her income will come from as the person enters his or her retirement years. Another issue that the person must grapple with is from where to withdrawal the funds to meet his or her needs. There is a need for a user-friendly tool that can be used to help solve these problems.

### SUMMARY OF THE INVENTION

The present invention relates to a computer system and method for use in retirement planning In an embodiment of the invention, the computer system comprises a computer or a server having a computer software application module for monitoring withdrawal activity associated with transactions in at least one financial account associated with a retirement plan. The computer or the server is communicatively connected to a computer-based device for displaying a retirement spending balance and withdrawal activity.

In another embodiment of the invention, the method comprises identifying by a computer a financial account within a retirement plan, assigning by the computer a unique code to each type of transaction activity for the financial account, identifying by the computer an actual withdrawal transaction by the unique code, and calculating an amount withdrawn from the retirement plan based on aggregating transaction amounts for the unique codes representing the actual withdrawal transaction.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a computer platform specially built for use with the user interface and computer software application tool(s) of the present invention

FIG. 2 illustrates a view of the withdrawal tool from a user interface.

FIG. 3 illustrates a pop-up box with financial account details.

FIG. 4 illustrates a custom withdrawal view under the client information section which provides an alternative to a systematic withdrawal.

FIG. 5 illustrates another view of the user interface having navigation and monitoring features.

FIG. 6 illustrates still another view of the user interface having navigation and monitoring features.

FIG. 7 illustrates a pop-up box for a user to choose a pre-defined period or to define a custom period.

FIG. 8 illustrates that a user may select a link or icon to see a pop-up box with the underlying withdrawal activity and related details.

FIG. 9 illustrates a spending schedule for monthly comparison as a feature of the withdrawal tool.

FIG. 10 illustrates a report having a withdrawal summary in accordance with aspects of the present invention.

FIG. 11 illustrates a report having a withdrawal summary having a monthly view in accordance with aspects of the present invention.

FIG. 12 illustrates a report having withdrawal monitoring assumptions included as part of the report in accordance with aspects of the present invention.

FIG. 13 illustrates a sample adjustment for inflation at a specific date in accordance with aspects of the present invention.

FIG. 14 illustrates a sample “look back” adjustment at a specific date in accordance with aspects of the present invention.

FIG. 15 illustrates calculation of plan spending and income sources for a trailing time period in accordance with aspects of the present invention.

FIG. 16 illustrates that transaction activity, including withdrawal transactions, is viewable in detail in accordance with aspects of the present invention.

FIG. 17 illustrates provision of statement activity in accordance with aspects of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

The computer system and portfolio withdrawal computer software application tool of the present invention is particularly suited for a user who is retired or who is within five years of retirement. The term “user” generally refers to a client or customer of a financial institution but may include, but is not limited to, a financial institution representative, a third-party financial advisor or other third-party acting on behalf of a client or customer. The portfolio withdrawal tool may work in correlation with other tools to take a deeper look at the remaining retirement spending balance needed. This tool is used as part of the computer system to build detailed withdrawal strategies to fully meet the spending needs of a person at or nearing retirement. The portfolio withdrawal method of the present invention combines data from a retirement plan with retirement planning tools. The withdrawal tool of the present invention provides a user the ability to enter a principal withdrawal by percentage or monetary value. The withdrawal tool integrates account details such as market value and cost basis for each account included in the analysis. It generates an easy-to-understand report for use with a client.

The user interface has monitoring functionality and reporting functionality that provides a bridge between the conceptual and the actual. Retirement plan spending amounts are compared to the actual activity in the portfolio. In a preferred aspect of the invention, all accounts are included because in reality withdrawals may be coming out of any account in the portfolio to meet spending goals. If a client wants external assets monitored, the external assets can be transferred so as to be included. Because withdrawals are viewed looking backwards, plan goals may need to be adjusted backwards to achieve a closer comparison. Current goals can be deflated over differing time periods. Goals that stop or start at specific dates impact the total amount needed in the time period.

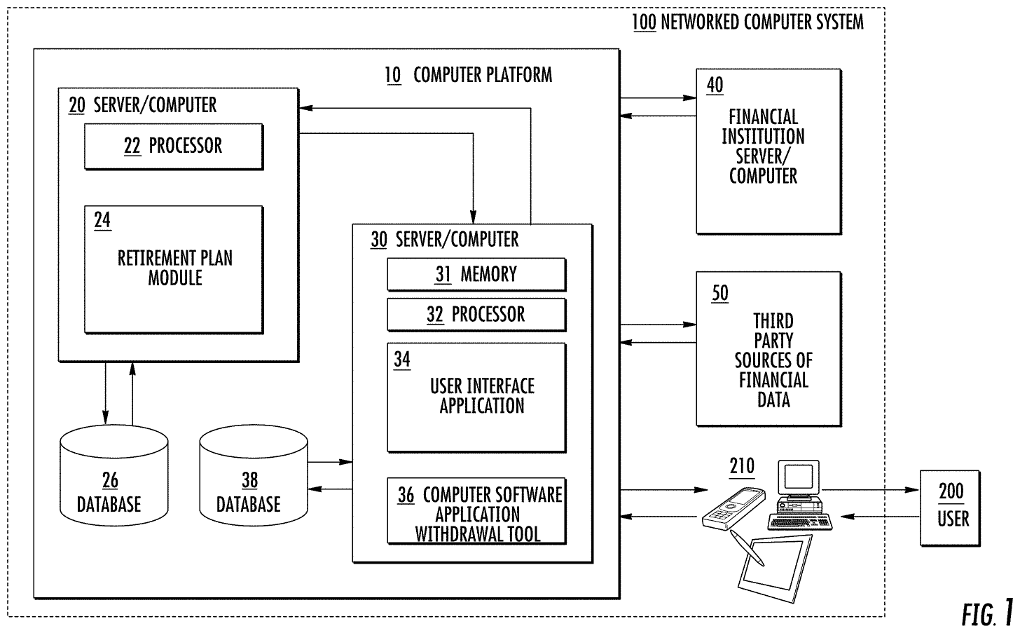

Referring to the figures, FIG. 1 illustrates a computer platform specially built for use with the user interface and computer software application tool(s) of the present invention. As shown in FIG. 1, a computer platform 10 operates in a networked computer system 100. The computer platform 10 is specially designed for use with a user interface application 34 and computer software application tool(s) 36 in accordance with the present invention. As shown in FIG. 1, server/computer 30 comprises memory 31, a processor 32, user interface application 34, and withdrawal software application tool(s) 36. The server/computer 30 can also store and access data and other information in a database 38. The computer platform 10 comprises computer hardware and software including server/computer 20 having one or more retirement plan modules 24 and a processor 22 capable of running such module(s) 24. The server/computer 20 can store and access data and other information in a database 26. The server/computer 20 and the server/computer 30 are communicatively connected with each other. The computer platform 10 is designed to present a customized user interface on a device 210 of a user 200. The user 200 may access the user interface application 34 with a computer-based device 210 such as a computer, tablet, mobile phone or other computer-based device. The user interface communicates with computer platform 10 to access data and account information from a retirement plan via the retirement plan module 24. The computer platform 10, as shown, is communicatively connected to one or more financial institution server/computers 40. The computer platform 10 may also be communicatively connected to one or more third party sources 50 of financial data.

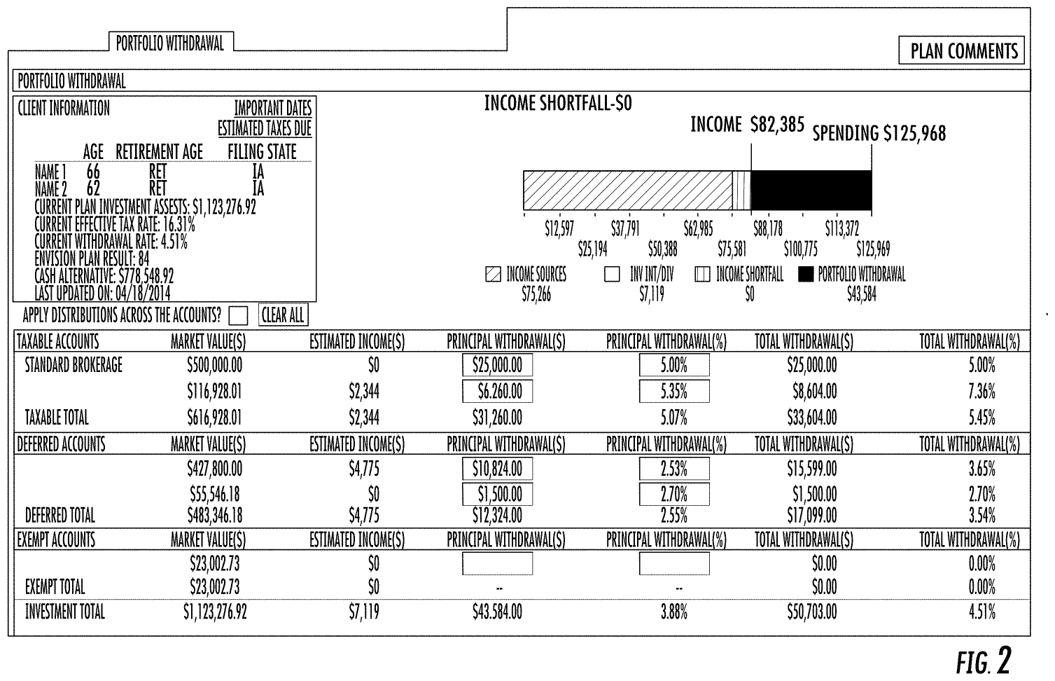

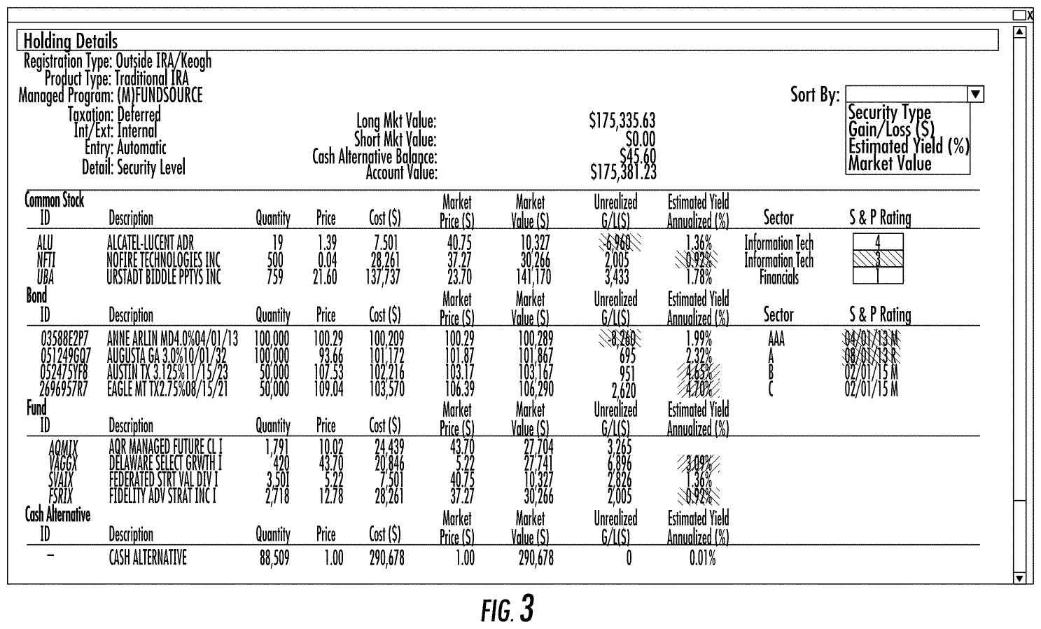

The withdrawal computer software application tool can be used prospectively, retrospectively, or a combination thereof FIG. 2 illustrates a view of the withdrawal tool from a user interface.

In an embodiment of the present invention, the withdrawal computer software application tool is used prospectively in a forward looking manner The tool is used to take a look at the remaining retirement spending balance needed and to use this functionality to build a detailed withdrawal strategy or strategies to fully meet the spending need. This tool is particularly suited for a client who is retired or within one to five years of retirement. The tool combines data from a retirement plan of a client and includes account details such as market value and cost basis for each included account. The tool provides a user the ability to enter a principal withdrawal by percentage or monetary amount such as dollar value. The tool provides a user the ability to create different withdrawal strategies for the shortfall identified and to generate customized reports.

FIG. 2 illustrates that a user may access the withdrawal tool via the user interface under the “Portfolio Withdrawal” tab on a computer-based device. As shown in FIG. 2, among its features, the “Client Information” box displays information used by the withdrawal tool computer software application. Examples of such information include, but are not limited to, dates and deadlines such as estimated tax deadlines. An “estimated taxes due” link displays current year taxes calculated from goals, income sources, investment interest, and dividends.

The bar graph in the upper right hand corner of FIG. 2 focuses on the balance needed to fulfill a total spending need. When this feature is first accessed, the income shortfall is illustrated. However, as portfolio dollars are used to decrease the shortfall and cover the entire need, the income shortfall amount decreases until it equals zero ($0). Thus, the withdrawal tool may be used in a forward looking manner to assist a user understand how the income needs in retirement can be met.

Among the features shown in FIG. 2 are: (1) account listings, (2) account information, (3) principal withdrawal, and (4) total withdrawal. Account listings are shown in the far left column and display accounts of a user by taxable, tax-deferred, or exempt. In a preferred aspect of the invention, the account listings include all of the accounts of the user. Account information refers to the information provided for each account. For example, the market value associated with each account followed by its estimated income, if available, is shown. A column is shown entitled “Principal Withdrawal(s)” that are actionable fields used to designate which accounts to recommend to use to meet the retirement spending need. Values can be entered either by percentage or dollar amount. Another column is shown entitled “Total withdrawal(s).” The fields automatically calculate based on entries in the Principal Withdrawal column by percentage or dollar amount. A “clear all” button can be used to reset all of the figures entered into the Principal Withdrawal column to view a different withdrawal strategy and to clear all changes for full customization. Thus, among the features of the custom withdrawal view are to provide a graphical depiction of a shortfall or gap and to offer cross calculation for withdrawal by percentage and dollar value.

In another embodiment of the present invention, the withdrawal computer software application tool is used retrospectively in a look back manner such as for purposes of monitoring.

The withdrawal tool computer software application 36 communicates with a retirement plan module 24, as shown in FIG. 1, to identify a spending goal for retirement and, as part of that process, to associate the accounts with that plan.

In accordance with an embodiment of the present invention, a method of the invention comprises identifying a financial account(s) within a retirement plan, assigning a unique code to each type of transaction activity on the financial account(s), identifying the code(s) representing an actual withdrawal from the retirement plan as compared to other activities such as a transfer from one account to another account within the retirement plan), calculating an amount withdrawn from the retirement plan based on aggregating transaction amounts for the codes representing an actual withdrawal transaction, and optionally graphically displaying a comparison of planned retirement plan withdrawals to actual retirement plan withdrawals during a previous time period.

As a feature of the computer software application withdrawal tool, a table or database of codes can be generated to identify withdrawals. The table can be manually generated, computer generated, or a combination thereof Once the table is generated, the computer software application tool in conjunction with the computer and computer processor automatically identifies actual withdrawals from the retirement plan by code.

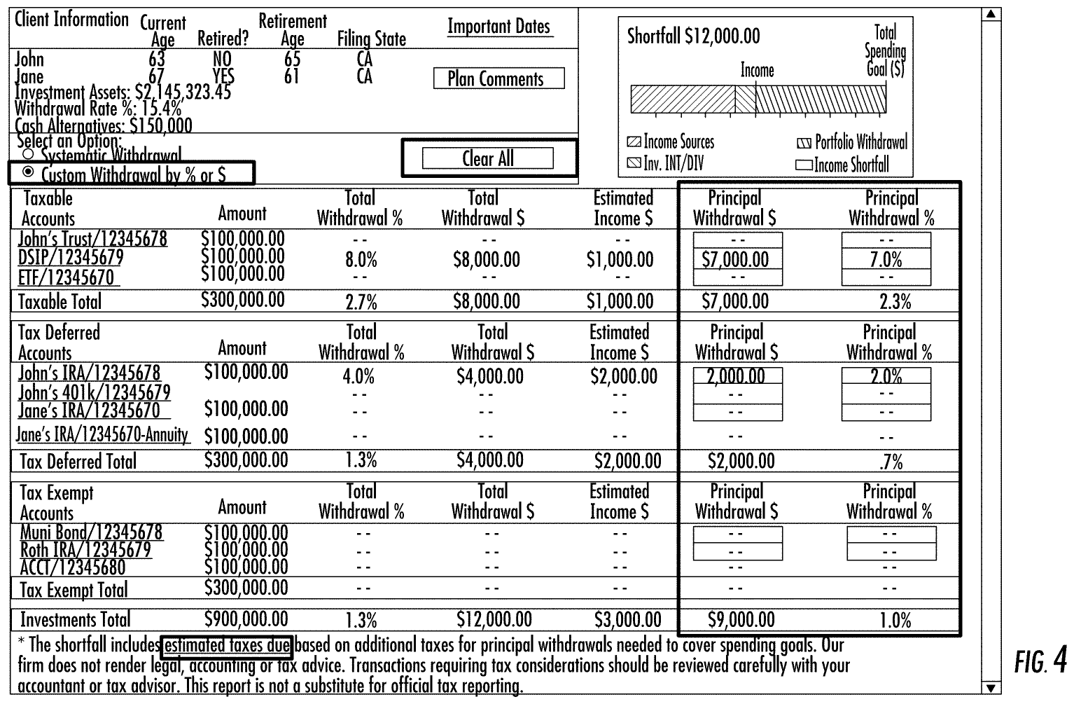

FIG. 3 illustrates a pop-up box with financial account details.

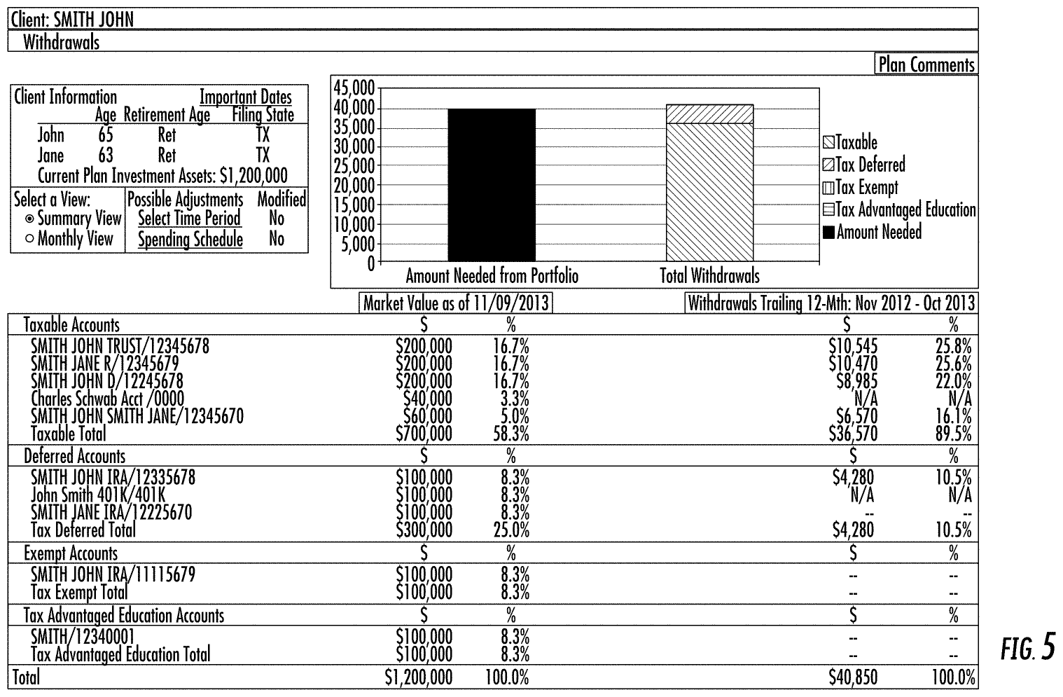

FIG. 4 illustrates a custom withdrawal view under the client information section which provides an alternative to a systematic withdrawal. A graphical depiction of the shortfall or gap from the total spending goal is shown. It offers cross-calculation for withdrawal by percentage and monetary amount such as in dollars. It provides a “clear all” button to clear all changes for full customization. There is also a link to a screen to assist with calculation of and withdrawals associated with estimated taxes.

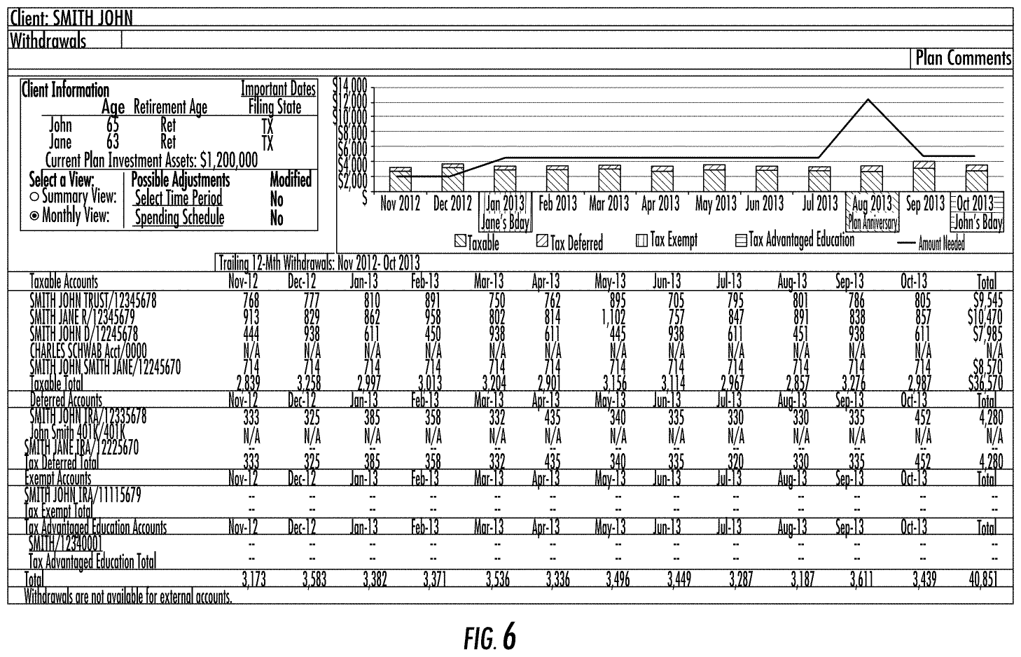

Another feature of the computer software application withdrawal tool is its navigation and monitoring features. FIGS. 5 and 6 illustrate additional views of the user interface having navigation and monitoring features.

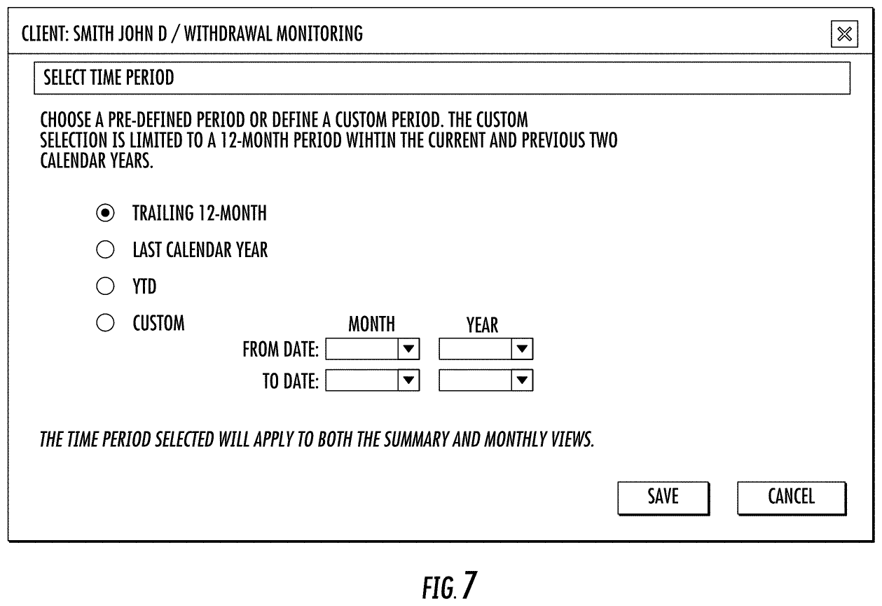

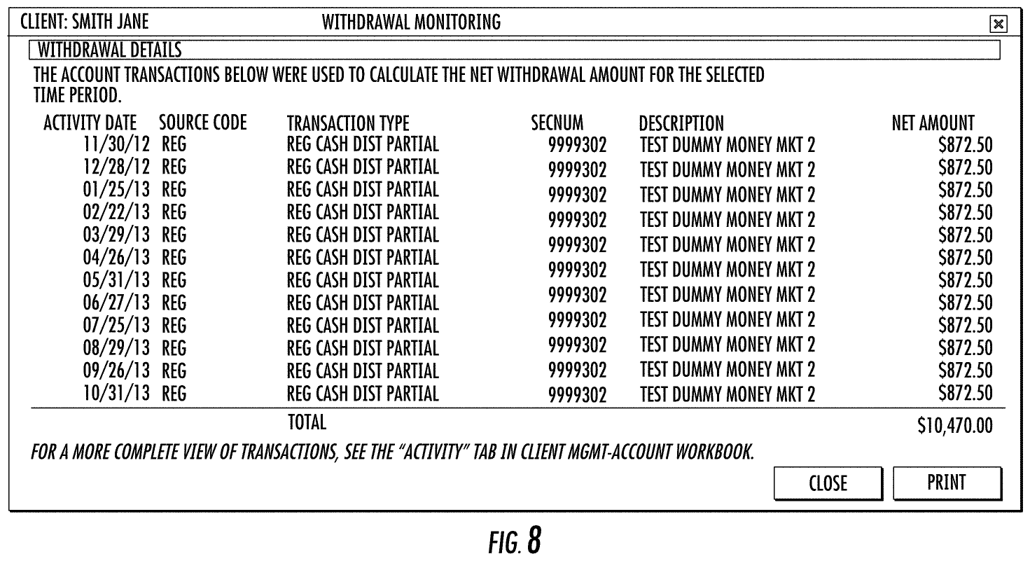

A user such as a financial advisor acting on behalf of a client, or a client directly, has control of time period for display and time of spending. There can be time period selection. FIG. 7 illustrates a pop-up screen for the user to choose a pre-defined period or to define a custom period. The custom selection, for example in FIG. 7, is limited to a twelve month period within the current and previous two calendar years. The pop-up shows options of trailing 12-month, last calendar year, year-to-date (YTD) and custom selection month/year to month/year. FIG. 8 illustrates that a user may select a link or icon to see a pop-up box with the underlying withdrawal activity and related details. The user has the visibility to the underlying transactions used to calculate the withdrawals.

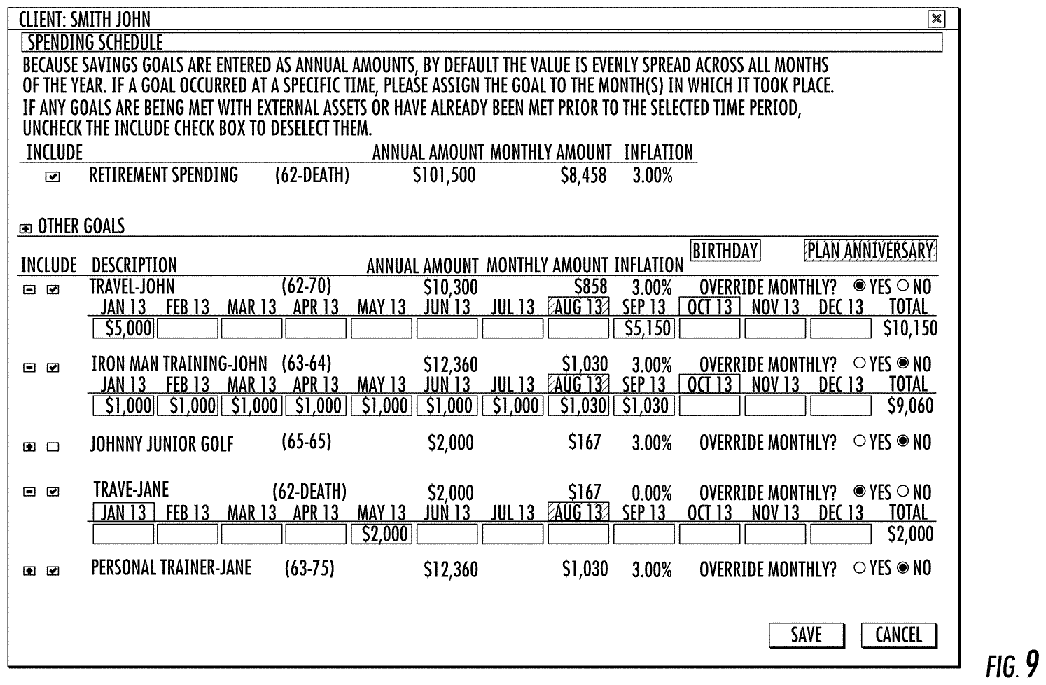

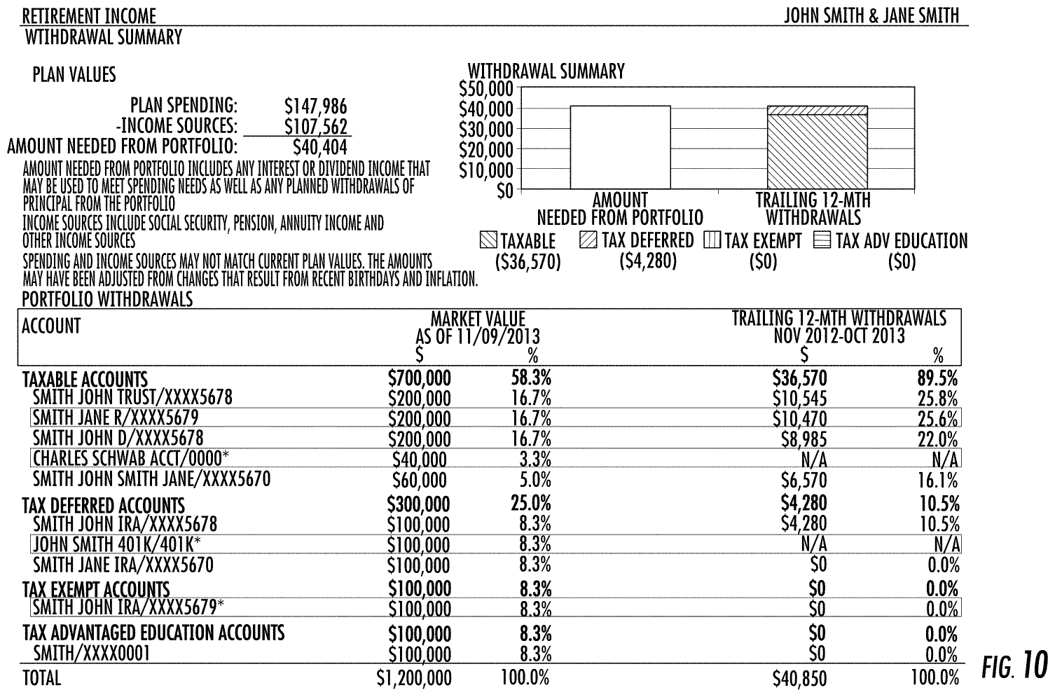

Another feature of the tool illustrated in FIG. 9 is a spending schedule for monthly comparison. Since not all spending goals are evenly spread across the months, the withdrawal tool provides a user such as a financial advisor the ability to schedule the spending goal to create a better comparison to the actual monthly withdrawals. For example, as illustrated in FIG. 9, Jane will be travelling in July, so she withdrawals $2000 in May to pay for her flight and expenses.

The monitoring feature of the computer software application tool provides a connection between conceptual goals in a retirement plan and actual withdrawals and investment income within the financial accounts included in the retirement plan. Among the reasons that the computer system of the present invention is special is that the computer system integrates both withdrawals and investment income in its monitoring function. It provides a unique method to identify and track withdrawals as well as to compare actual withdrawal activity with goals from a retirement plan with the option of a specific spending schedule. Investment income illustrates income generated by financial accounts to show whether it aligns with the assumptions modeled in the plan. The computer software withdrawal tool of the present invention is used to bridge the gap between planned spending with the actual account activity. The computer software withdrawal tool of the present invention provides the user the ability to view customizable time periods for cash flows along with the ability to set an editable spending schedule.

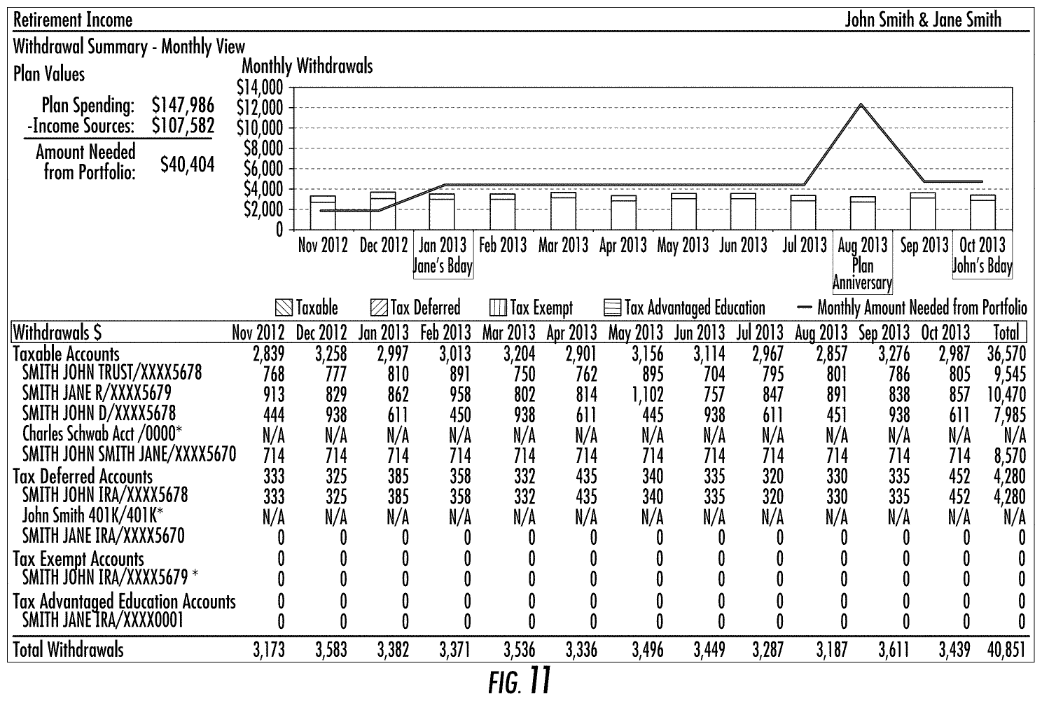

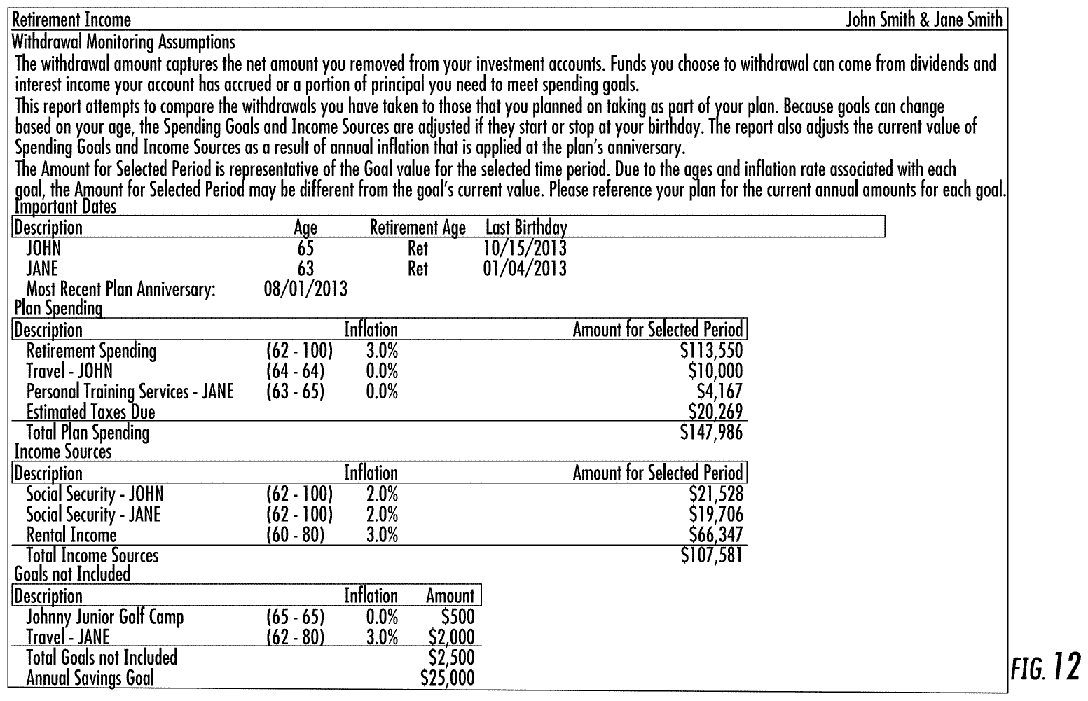

The withdrawal tool of the present invention has the functionality to compile and generate reports. Reports can be generated as shown in FIGS. 10-12. As shown in FIG. 10, the report can provide a withdrawal summary. The report can also provide a withdrawal summary having a monthly view as shown in FIG. 11.

The withdrawal tool may operate under certain withdrawal monitoring assumptions. The withdrawal amount captures the net amount a user such as a customer, for example, removed from his/her investment accounts. The funds a user chooses to withdrawal can come from dividends and interest income the account has accrued or a portion of principal needed to meet spending goals. Withdrawal monitoring assumptions are included as part of a generated report as shown in FIG. 12. The report attempts to compare the withdrawals taken to those that are planned on being taken as part of a retirement plan. Because goals can change based on age, the spending goals and income sources are adjusted, for example, if they stop or start at a customer's birthday. Under “Income Sources,” the “Amount for Selected Period” is representative of the retirement goal value for the selected time period. Due to the ages and inflation rate associated with each goal, the “Amount for Selected Period” may be different from the current value of the goal. The retirement plan can be referenced for the current annual amounts for each goal.

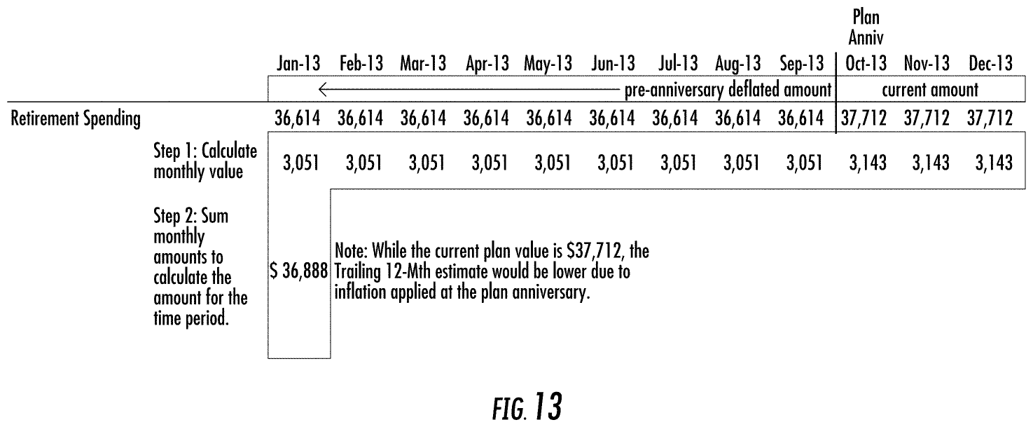

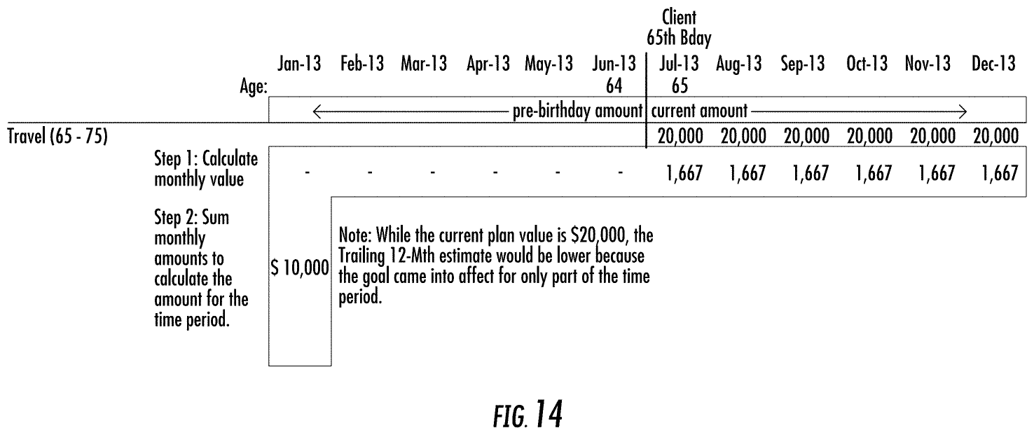

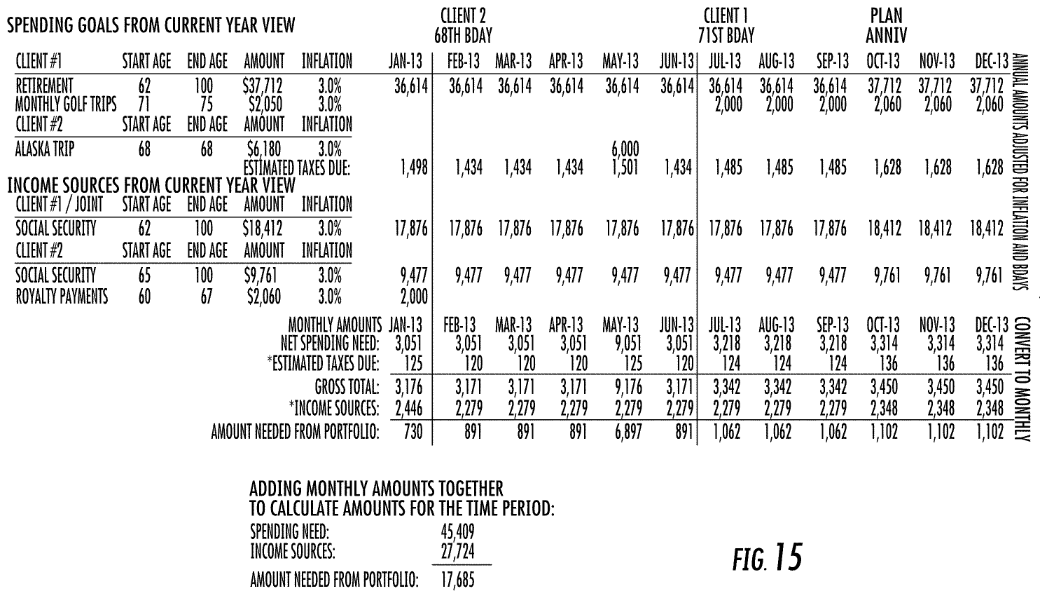

The withdrawal tool also has functionality to provide for certain “look back” adjustments. For example, FIG. 13 illustrates a sample adjustment for inflation at a retirement plan anniversary. In this example, note that while the current plan value is $37,712, the trailing 12-month estimate would be lower due to inflation applied at the specified point in time. FIG. 14 illustrates a sample “look back” adjustment for age at birthday. In this example, note that while the current plan value is $20,000, the trailing 12-month estimate would be lower because the goal came into affect for only part of the time period.

It is possible to calculate plan spending and income sources for a trailing time period as illustrated in FIG. 15.

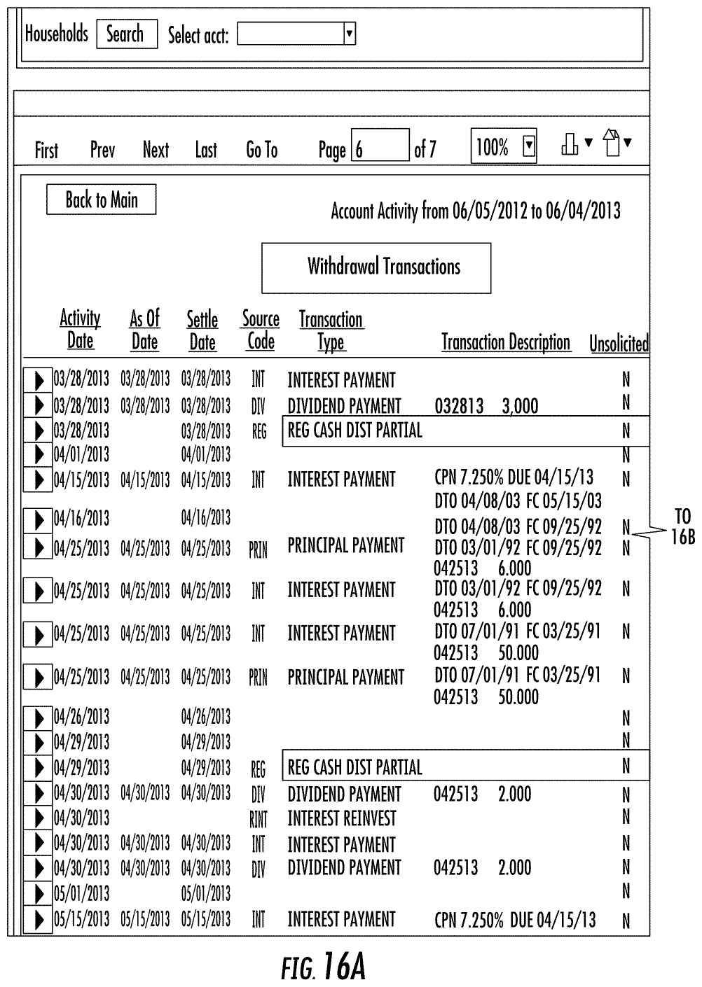

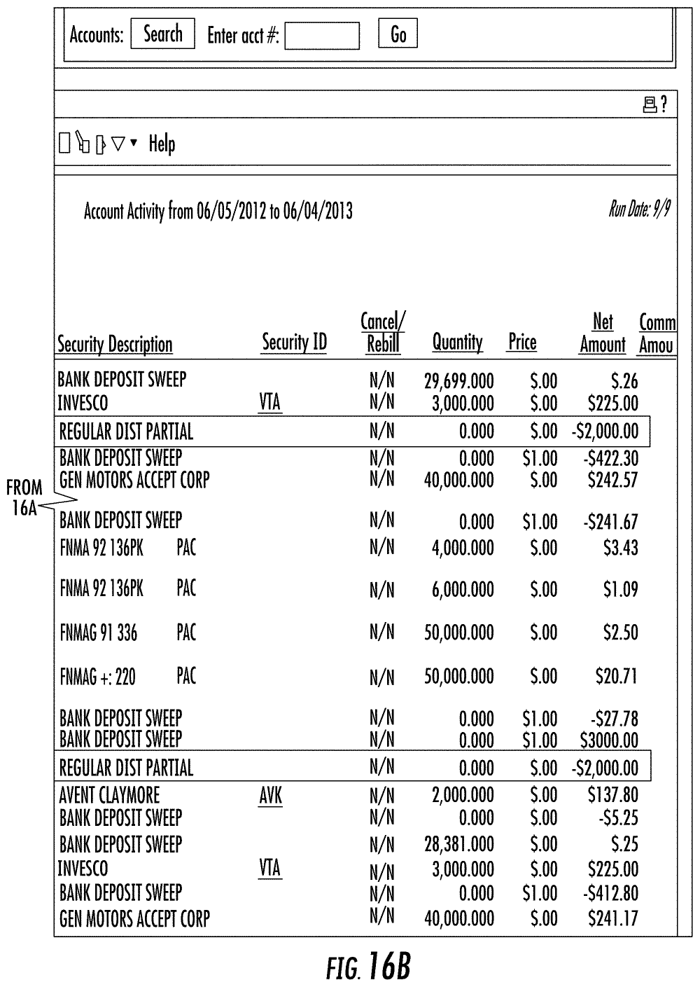

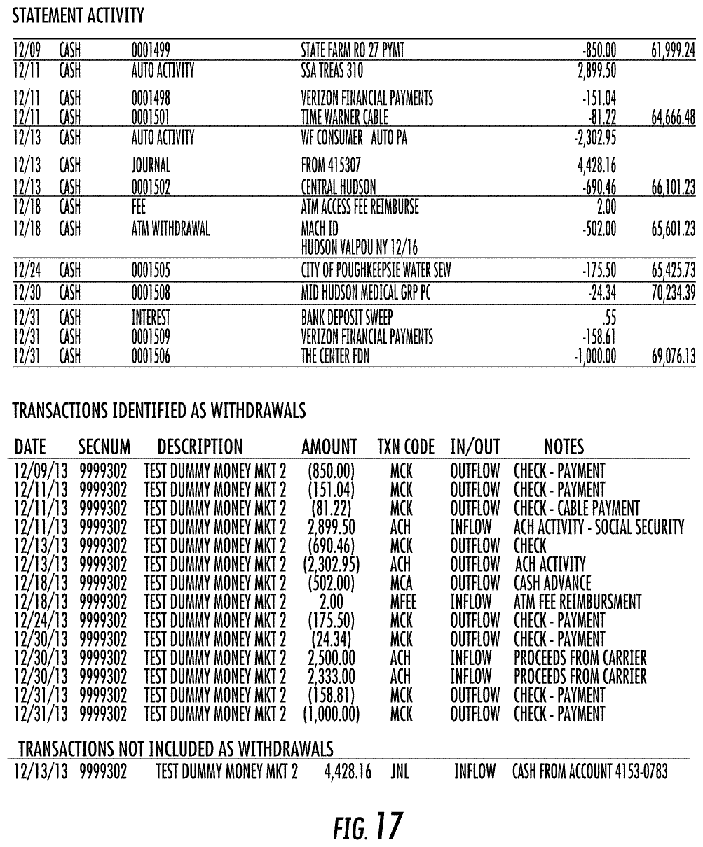

A feature of the computer system of the present invention having the computer software application withdrawal tool is that various data sources may be accessed for purposes of gathering withdrawal information. Transaction activity, including withdrawal transactions, can be viewed in detail as illustrated in FIG. 16. Statement activity can also be provided as shown in FIG. 17.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention.

Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

1. A method of real-time processing of retirement plan calculations comprising:
providing a memory and a processer that when configured with instruction from the memory, enact steps comprising computer platform comprised of:
associating a retirement plan with a full set of all financial accounts of a user, wherein the full set of all financial accounts comprises a taxable account, a tax-deferred account, an exempt account, a tax advantaged account, and a combination thereof;
generating, in a user interface application, a column of actionable fields, wherein the actionable fields are programmed to receive input and based on that input, provide cross-calculations for goals of the retirement plan in at least percentage and dollar value;
assigning a unique code to each type of transaction activity for the financial account;
identifying a projected withdrawal transaction by the unique code; and
calculating an amount withdrawn from the retirement plan based on aggregating transaction amounts for unique codes representing the projected withdrawal transaction;
wherein the calculating includes the provided cross-calculations that are computed in real-time across the full set of all financial accounts, and the goals are deflated over differing time periods indicated in the column of actionable fields for the full set of all financial accounts.

2. The method according to claim 1, further comprising graphically displaying with the user interface application a comparison of planned retirement plan withdrawals to actual retirement plan withdrawals during a selected time period.

3. (canceled)

4. (canceled)

5. (canceled)

6. The method according to claim 1, further comprising automatically identifying actual withdrawals from the retirement plan by the unique code.

7. The method according to claim 2, further comprising graphically depicting a shortfall or a gap from a retirement spending balance with the user interface application.

8. The method according to claim 1, further comprising generating a report of withdrawal activity.

9. The method according to claim 2, further comprising displaying account withdrawal activity and related data with the user interface application.

10. The method according to claim 1, further comprising monitoring withdrawal activity by the unique code for a withdrawal transaction.

11. The method according to claim 1, further comprising presenting with the user interface application a withdrawal strategy to meet a retirement spending balance needed for the goals of the retirement plan.

12. A computer system for retirement planning, the computer system comprising:
a computer having a memory and a processor that when configured with instructions from the memory, enacts steps of:
associating a retirement plan with a full set of all financial accounts of a user, wherein the full set of all financial accounts comprises a taxable account, a tax-deferred account, an exempt account, a tax advantaged account, and a combination thereof;
generating, in a user interface application, a column of actionable fields, wherein the actionable fields are programmed to receive input and based on that input, provide cross-calculations for goals of the retirement plan in at least percentage and dollar value;
assigning a unique code to each type of transaction activity for the financial account;
identifying a projected withdrawal transaction by the unique code; and
calculating an amount withdrawn from the retirement plan based on aggregating transaction amounts for unique codes representing the projected withdrawal transaction;
wherein the calculating includes the provided cross-calculations that are computed in real-time across the full set of all financial accounts, and the goals are deflated over differing time periods indicated in the column of actionable fields for the full set of all financial accounts, and wherein the actionable fields provide customizable time periods of cash flows and set an editable spending schedule.

13. (canceled)

14. The computer system according to claim 12, wherein the calculating integrates withdrawals and investment income.

15. (canceled)

16. (canceled)

17. The computer system according to claim 12, wherein the user interface application depicts a shortfall or a gap from a retirement spending balance needed for the goals of the retirement plan.
